(19) United States
(12) Patent Application Publication
(10) Pub. No.: US 2014/0087260 A1
(43) Pub. Date: Mar. 27, 2014

(54) POSITIVE ELECTRODE FOR LITHIUM ION SECONDARY BATTERY, LITHIUM ION SECONDARY BATTERY, AND BATTERY SYSTEM

(71) Applicant: HITACHI, LTD., Tokyo (JP)

(72) Inventors: Yuko KISHIMI, Osaka (JP); Mitsuhiro KISHIMI, Osaka (JP)

(73) Assignee: HITACHI, LTD., Tokyo (JP)

(21) Appl. No.: 13/790,421

(22) Filed: Mar. 8, 2013

(30) Foreign Application Priority Data
Sep. 27, 2012 (JP) 2012-213733

(51) Int. Cl. H01M 4/131

(52) U.S. Cl. CPC H01M 4/131
USPC 429/221

(57) ABSTRACT

Provided is a positive electrode for a lithium ion secondary battery including, as a positive active material, a positive active material (A) that is LiFePO₄ having an olivine structure and a positive active material (B) expressed by a general formula: yLi₂MnO₃.(1−y)LiMO₂ (y satisfies 0.3≦y≦0.7, and M represents at least two kinds of elements selected from the group consisting of Co, Mn, Ni, Fe, and Ti so that a total valence becomes three, the positive active material (A) having a mass ratio of 80 to 90% by mass with respect to the total mass of the positive active material (A) and the positive active material (B); a lithium ion secondary battery including the positive electrode; and a battery system including the lithium ion secondary battery and a charge and discharge control portion for controlling the charge and discharge of the lithium ion secondary battery with a voltage.

### BACKGROUND OF THE INVENTION

1. Field of the Invention

The present invention relates to a lithium ion secondary battery capable of satisfying both high effective capacity and high energy density when applied to a battery system having a charge and discharge control portion for controlling charge and discharge of the lithium ion secondary battery with a voltage, a positive electrode constituting the lithium ion secondary battery, and the battery system.

2. Description of Related Art

Lithium ion secondary batteries are being developed at high speed as batteries to be used in portable electronic devices, hybrid automobiles, and the like.

When a lithium ion secondary battery is used in a battery system having a charge and discharge control portion for controlling charge and discharge of the battery with a voltage, a voltage range in which the battery is operated actually is set to be narrower than a rated voltage range of each battery on the system, considering safety of the battery, for reasons such as a voltage detection error, variations in resistances and characteristics of respective batteries in the case where a plurality of batteries is used, and the like. In this case, there arises a problem in that the capacity of a battery becomes smaller than rated capacity that is feasible at a rated voltage.

Further, as a battery degrades due to the continuous use thereof, resistance increases; and a closed circuit voltage rises during charge, whereas a closed circuit voltage drops during discharge, which causes a decrease in capacity. Therefore, it should be assumed that capacity in the vicinity of each termination voltage may not be extracted at the end of the life of the battery. For example, in a battery system equipped with a battery that is operated at a rated voltage of 2.5 to 4.2 V, capacity expressed at a voltage of 2.55 to 4.15 V smaller than the above-mentioned rated voltage can only be extracted. Further, in a state in which a battery has been degraded, capacity expressed at a voltage of about 3 to 4 V, at which the battery had been operated initially, can only be extracted.

In the case where a battery system is used in a storage battery for a generator, a condition under which a state of charge (SOC) does not reach 100%, that is, the storage battery is not fully charged is generally assumed. Therefore, for example, even when a battery operated at a rated voltage of 2.5 to 4.2 V is used, and capacity expressed at a voltage of 2.55 to 4.15 V can only be utilized actually, there is no inconvenience. However, depending on the power generating condition in a generator, power may be generated with the SOC of a battery used together with a battery system exceeding the assumed level. Particularly, in power generation using natural energy, it is impossible to predict and control a power generation amount precisely under the current circumstances, and hence, there is a demand for handling various SOC levels. Accordingly, in order to make the best use of generated electricity without causing problems in a battery system under such circumstances and without wasting the generated electricity, a battery to be used in the battery system is required to have the ability to be used also in a very high SOC region so as to realize high effective capacity.

As a procedure for responding to the above-mentioned request in a lithium ion secondary battery to be used in a battery system, for example, it is conceivable to use a material that has a wide potential flat portion and is less degraded, such as LiFePO₄ having an olivine structure, for a positive active material. In a lithium ion secondary battery using such a positive active material, a potential becomes flat in a wide range of an SOC of about 95% or more, and capacity can be extracted efficiently even in the vicinity of a termination voltage of charge and discharge.

In a battery system using a lithium ion secondary battery that includes Li(Ni_{1/3}Mn_{1/3}Co_{1/3})O₂, known as a positive active material having relatively high capacity, as a positive active material and graphite as a negative active material, and a battery system using a lithium ion secondary battery that includes LiFePO₄ as a positive active material and graphite as a negative active material, charge and discharge characteristics were measured at a current value of 0.2C. FIG. 1 shows charge and discharge curves illustrating relationships between the voltage and the SOC of a battery. In FIG. 1, a horizontal axis represents an SOC (%) of a lithium ion secondary battery, and a vertical axis represents a battery voltage (V). In FIG. 1, reference symbol “X” represents charge and discharge curves of the battery system using a lithium ion secondary battery that includes Li(Ni_{1/3}Mn_{1/3}Co_{1/3})O₂ as a positive active material, and reference symbol “Y” represents charge and discharge curves of the battery system using a lithium ion secondary battery that includes LiFePO₄ as a positive active material. Reference symbol “A” represents a voltage range that is available substantially, and reference symbol “B” represents capacity that is not available substantially during charge in a high SOC region. Herein, each of the lithium ion secondary batteries is operated at 2.5 to 4.2 V, and in each of the battery systems, a substantially available voltage range A was 2.55 to 4.15 V.

Hereinafter, the above-mentioned “capacity that is not available substantially” is described. As mentioned above, there are variations in resistances, characteristics, and the like of respective batteries. Therefore, in the case of a battery system in which a plurality of batteries is operated simultaneously, the battery system is used actually in a voltage range narrower than a rated range in order to avoid a problem that a part of the batteries is operated at a voltage outside of a rated range. For example, in the case of a battery system including a plurality of batteries the rated range of which is 2.5 to 4.2 V, in order to control all the batteries so that their operation voltages fall within a range of 2.5 to 4.2 V, the battery system is to be used actually in a voltage range of 2.55 to 4.15 V considering variations in the individual batteries. Thus, the “capacity that is not available substantially” refers to capacity obtained by subtracting capacity which a battery expresses in an actual voltage range (for example, 2.55 to 4.15 V) from capacity which the battery expresses in a rated range (for example, 2.5 to 4.2 V). Further, the “capacity that is not available substantially during charge” refers to capacity which a battery expresses in a voltage range (for example, 4.15 to 4.2 V) from an upper limit value of an actual operation voltage to an upper limit value of a rated voltage, and the “capacity that is not available substantially during discharge” refers to capacity which a battery expresses in a voltage range (for example, 2.5 to 2.55 V) from a lower limit value of a rated voltage to a lower limit value of an actual operation voltage.

As represented by “X” in FIG. 1, in the battery system using Li(Ni_{1/3}Mn_{1/3}Co_{1/3})O₂ as a positive active material, a voltage changed gently in a wide range of a high SOC region. In the case where the battery system was used at 2.5 to 4.2 V, the capacity B that was not available substantially during charge was about 5% in a region with a very high SOC. That is, unused capacity of about 5% occurred. In contrast, as represented by “Y” in FIG. 1, in the battery system using a battery including LiFePO₄ as a positive active material, a voltage rose abruptly at the very end of a high SOC region. Therefore, unused capacity was suppressed to less than 1%, and capacity of 99% or more was used effectively.

Further, LiFePO₄ is degraded less by repeated charge and discharge of a battery and is effective for extending the life of the battery. Therefore, a battery system using a battery including LiFePO₄ as a positive active material also has an advantage in that more capacity can be extracted, even when used for a long period of time.

However, LiFePO₄ also has a problem of low energy density due to its low operation voltage of 3.2 to 3.3 V. For example, a lithium ion secondary battery that includes Li(Ni_{1/3}Mn_{1/3}Co_{1/3})O₂ as a positive active material and graphite as a negative active material exhibits an energy density of about 530 Wh/kg, whereas a lithium ion secondary battery that includes LiFePO₄ as a positive active material and graphite as a negative active material exhibits an energy density of about 480 Wh/kg.

As a procedure for enhancing energy density in the battery using LiFePO₄ having such characteristics, it is conceivable to use LiFePO₄ together with another positive active material having high energy density.

For example, JP 2011-228293 A discloses the following: when a battery is configured through use of LiMO₂ (M=Ni, Mn, Co) having a high operation voltage together with 5 to 25% by weight of LiFePO₄, LiFePO₄ having an operation voltage higher than that of LiMO₂ is operated in a region of a low SOC (e.g., about 10%) to reduce an energy density difference between an SOC of 10% and an SOC of 20% and to realize high energy density.

However, in the case of the battery described in JP 2011-228293 A, charge and discharge curves of LiMO₂ having no potential flat portion become dominant in a wide SOC range. In the case where the battery is utilized in a battery system, effective capacity becomes about 95% which is substantially equivalent to the effective capacity obtained in the case of using LiMO₂ alone. In order to make the best use of the potential flat portion of LiFePO₄ and effectively extract a wide range of capacity in an actual battery system, the content of LiFePO₄ in a positive active material should be set to at least about 75% by mass. In this case, the problem that energy density is still low (at most about 490 Wh/kg) remains unsolved, which has been found by the study of the inventors of the present invention.

Further, JP 2009-245808 A discloses the following: when a battery is configured through use of both LiFePO₄ and Li₂MnO₃ as a positive active material for a positive electrode, in which the amount of Li₂MnO₃ is set to 20 to 80% by weight, high capacity is realized, and a potential changes in a wider SOC range, which is advantageous for monitoring remaining capacity.

The energy density of the positive active material (mixture of LiFePO₄ and Li₂MnO₃) described in JP 2009-245808 A is about 500 to 540 Wh/kg, which is relatively high, according to the study of the inventors of the present invention. However, when it is assumed that these batteries are applied to battery systems, the substantially available capacity is predicted to be 93 to 96% from charge and discharge curves of the batteries described in JP 2009-245808 A, which is not still enough.

Further, JP 2012-33507 A discloses the following: when a battery is configured through use of a positive electrode including various lithium manganese-containing oxides and LiFePO₄ and a negative electrode including a titanium-containing metal oxide, the surface of the titanium-containing metal oxide of the negative electrode is protected by an iron element derived from LiFePO₄ to prevent the negative electrode from being degraded, and hence, high-temperature storage can be enhanced. In the battery described in JP 2012-33507 A, LiFePO₄ is used for protecting the surface of a negative active material, and the amount of LiFePO₄ is set to 1 to 80% by weight, preferably 2 to 60% by weight with respect to 100% by weight of the lithium manganese-containing oxides.

However, the lithium manganese-containing oxides actually used in the technology described in JP 2012-33507 A are LiMO₂ (M=Mn, Ni, Co, Al) and Li₂MnO₃, and hence, these materials are insufficient for satisfying both the high energy density and the high effective capacity in a battery system in the same way as in the case of the technologies described in JP 2011-228293 A and JP 2009-245808 A.

### SUMMARY OF THE INVENTION

Therefore, with the foregoing in mind, it is an object of the present invention to provide a lithium ion secondary battery capable of satisfying both high effective capacity and high energy density when applied to a battery system having a charge and discharge control portion for controlling charge and discharge of the lithium ion secondary battery with a voltage, a positive electrode constituting the lithium ion secondary battery, and the battery system.

A positive electrode for a lithium ion secondary battery of the present invention includes a positive electrode mixture layer containing a positive active material, a conductive aid, and a binder. The positive electrode mixture layer contains, as the positive active material, a positive active material (A) that is LiFePO₄ having an olivine structure and a positive active material (B) expressed by a general formula: yLi₂MnO₃.(1−y)LiMO₂, where y satisfies 0.3≦y≦0.7, and M represents at least two kinds of elements selected from the group consisting of Co, Mn, Ni, Fe, and Ti so that a total valence become three, and the positive active material (A) has a mass ratio of 80 to 90% by mass with respect to a total mass of the positive active material (A) and the positive active material (B).

Further, a lithium ion secondary battery of the present invention includes a positive electrode, a negative electrode, a separator, and a nonaqueous electrolyte solution, and the positive electrode is the positive electrode for a lithium ion secondary battery of the present invention.

Further, a battery system of the present invention includes the lithium ion secondary battery of the present invention, and a charge and discharge control portion for controlling charge and discharge of the lithium ion secondary battery with a voltage.

The present invention can provide a lithium ion secondary battery capable of satisfying both high effective capacity and high energy density when applied to a battery system having a charge and discharge control portion for controlling charge and discharge of the lithium ion secondary battery with a voltage, a positive electrode constituting the lithium ion secondary battery, and the battery system.

### BRIEF DESCRIPTION OF THE DRAWINGS

FIG. 1 is a graph showing charge and discharge curves in a battery system using a lithium ion secondary battery including Li(Ni_{1/3}Mn_{1/3}Co_{1/3})O₂ as a positive active material and graphite as a negative active material, and a battery system using a lithium ion secondary battery including LiFePO₄ as a positive active material and graphite as a negative active material.

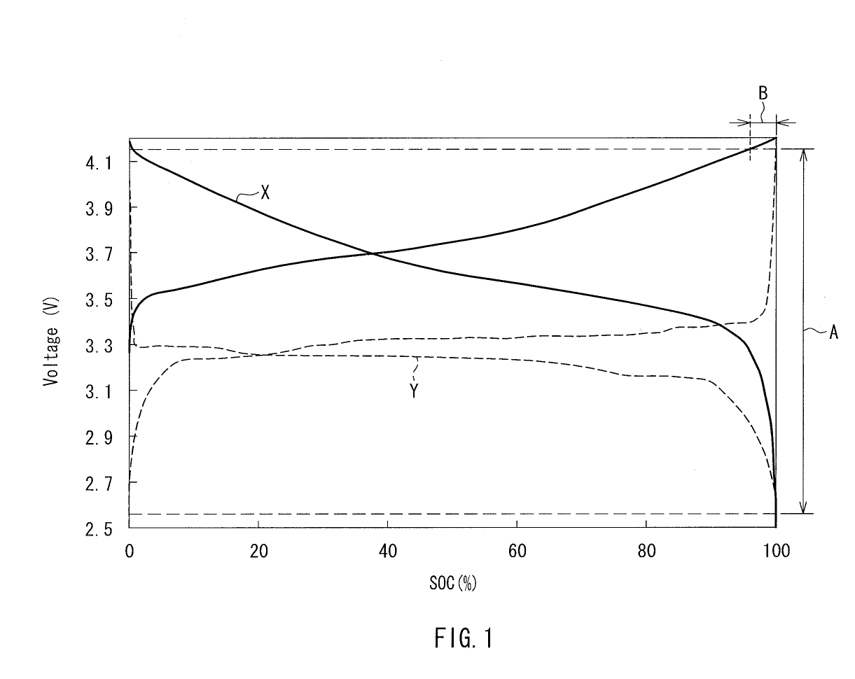

FIG. 2 is a graph showing charge and discharge curves in an electron system using a lithium ion secondary battery of Example 1.

FIG. 3 is a graph showing charge and discharge curves in an electron system using a lithium ion secondary battery of Comparative Example 3.

### DETAILED DESCRIPTION OF THE INVENTION

A positive electrode for a lithium ion secondary battery of the present invention (hereinafter, simply referred to as “positive electrode”) has a structure in which a positive electrode mixture layer including a positive active material, a conductive aid, and a binder is disposed on one surface or both surfaces of a collector.

The positive electrode of the present invention uses, as a positive active material, a positive active material (A) that is LiFePO₄ having an olivine structure and a positive active material (B) expressed by a general formula: yLi₂MnO₃.(1−y)LiMO₂ (y satisfies 0.3≦y≦0.7, and M represents at least two kinds of elements selected from the group consisting of Co, Mn, Ni, Fe, and Ti so that the total valence becomes three).

The positive electrode of the present invention uses LiFePO₄ having an olivine structure as a positive active material. Therefore, in the case where the positive electrode is used in a battery constituting a battery system for controlling charge and discharge with a voltage, a lithium ion secondary battery can be obtained, which is capable of performing charge and discharge even in a high SOC region and has high effective capacity.

On the other hand, as described above, energy density is low in a lithium ion secondary battery using LiFePO₄ having an olivine structure as a positive active material. In the positive electrode of the present invention, not only LiFePO₄ having an olivine structure but also the positive active material (B) expressed by the above-mentioned general formula are used, and the ratio therebetween is specified. Thus, in the case where the positive electrode is used in the above-mentioned battery system, a lithium ion secondary battery can be configured, which has high energy density while maintaining high effective capacity.

As LiFePO₄ having an olivine structure that is the positive active material (A), materials that are generally used as positive active materials for lithium ion secondary batteries can be used.

There is no particular limit to the particle diameter of LiFePO₄ having an olivine structure, as long as it is similar to that of LiFePO₄ that is used generally. Specifically, for example, LiFePO₄ having a primary particle diameter of tens of nm to several μm can be used.

The primary particle diameter of LiFePO₄ having an olivine structure as used herein refers to a number average particle diameter obtained for 100 LiFePO₄ particles by observing LiFePO₄ with a transmission-type electron microscope (TEM). In the case where the LiFePO₄ particle does not have a spherical shape (in the case where the LiFePO₄ particle does not have a perfect circular shape in a TEM image), a particle diameter of each fine particle is defined as an average value of a major axis (longest diameter) and a minor axis (shortest diameter).

LiFePO₄ having an olivine structure does not have sufficient conductivity, and hence, it is preferred to cover LiFePO₄ having an olivine structure with carbon. In this case, the conductivity in the positive electrode mixture layer can be ensured more satisfactorily.

As a method for covering LiFePO₄ having an olivine structure with carbon, conventionally known methods can be used. Specific examples thereof include general covering methods such as a method for firing a mixture of an organic material to be a carbon precursor and LiFePO₄, and a method for depositing carbon on the surface of LiFePO₄ while decomposing gas to be a carbon precursor by a chemical vapor deposition (CVD) method.

The covering amount of carbon in the case where LiFePO₄ having an olivine structure is covered with carbon is preferably 1 part by mass or more with respect to 100 parts by mass of LiFePO₄ having an olivine structure, from the viewpoint of ensuring sufficient conductivity to prevent inactive LiFePO₄ from being present in the positive electrode mixture layer as soon as possible so as to perform a charge and discharge reaction more efficiently in a lithium ion secondary battery. It should be noted that, when the amount of carbon on the surface of LiFePO₄ is too large, carbon serves as a barrier during an insertion/removal reaction of lithium (Li) ions, which may degrade load characteristics of the lithium ion secondary battery. Accordingly, it is preferred that the covering amount of carbon on the surface of LiFePO₄ be 5 parts by mass or less with respect to 100 parts by mass of LiFePO₄ having an olivine structure.

The positive active material (B) for the positive electrode of the present invention is a material expressed by a general formula: yLi₂MnO₃.(1−y)LiMO₂ (y satisfies 0.3≦y≦0.7, and M represents at least two kinds of elements selected from the group consisting of Co, Mn, Ni, Fe, and Ti so that the total valence becomes three).

The positive active material (B) expressed by the above-mentioned general formula is a crystalloid having a rock salt type layered structure in which Li₂MnO₃ and LiMO₂ have oxygen as a common lattice and respectively create domains of a nanometer size to form a solid solution. When the positive active material (B) is once charged to 4.5 to 4.6 V or more, the positive active material (B) is activated and exhibits a high capacity of 300 mAh/g or more depending upon a composition ratio (that is, a value of y in the general formula). Specifically, for example, JP 2011-233234 A discloses that a material having a high capacity of 300 mAh/g can be obtained by forming a solid solution containing Li₂MnO₃ and LiNi_{1/3}Mn_{1/3}Co_{1/3}O₂ in a ratio of 1:1 (that is, y in the above-mentioned general formula is 0.5).

It is preferred that the element M in the positive active material (B) have, for example, the following composition ratio: Ni_{1/3}Mn_{1/3}Co_{1/3}, Ni_{1/4}Mn_{1/4}Co_{1/2}, Ni_{1/5}Mn_{1/5}Co_{3/5}, Ni_{2/5}Mn_{2/5}Co_{1/5}, or Ni_{1/3}Mn_{1/3}Fe_{1/3}, because a positive active material having satisfactory charge and discharge characteristics is obtained.

The value of y of Li₂MnO₃ in the positive active material (B) is 0.3 or more, preferably 0.35 or more, and 0.7 or less, preferably 0.6 or less, from the viewpoint of increasing the amount of active Li ions contained in the positive active material (B). As the value of y is smaller, charge and discharge stability is enhanced, and a satisfactory material that is less degraded by a charge and discharge cycle of a battery is obtained. However, when the value of y is too small, the amount of Li ions decreases, which is not preferred for realizing high energy density of a battery. On the other hand, it is not preferred that the value of y is too large, because a stable layered structure is not formed, and all the contained Li ions cannot be activated, with the result that capacity decreases while the value of y increases.

The average primary particle diameter of the positive active material (B) is preferably 3 μm or less, more preferably 2 μm or less, from the viewpoint of increasing its activity to enhance capacity further. When the average primary particle diameter of the positive active material (B) is small, the reactivity thereof during charge and discharge is enhanced, and there is no problem for battery characteristics. However, when the average primary particle diameter of the positive active material (B) is too small, it is difficult to synthesize the positive active material (B), and there is a possibility that the positive active material (B) is not dispersed easily in a positive electrode mixture layer during production of a positive electrode. Thus, the average primary particle diameter of the positive active material (B) is preferably 100 nm or more, more preferably 200 nm or more.

The average primary particle diameter of the positive active material (B) as used herein refers to a value that can be measured by the same method as a method for measuring a particle diameter (number average particle diameter) of the positive active material (A).

In the positive electrode of the present invention, a ratio of the mass of the positive active material (A) with respect to the total mass of the positive active material (A) and the positive active material (B) is set to 80% by mass or more, preferably 82% by mass or more, from the viewpoint of reducing the above-mentioned unused capacity in a battery system having a lithium ion secondary battery using the positive electrode of the present invention.

Further, in the positive electrode of the present invention, a ratio of the mass of the positive active material (A) with respect to the total mass of the positive active material (A) and the positive active material (B) is set to 90% by mass or less.

The following is known about the positive active material (B) expressed by the above-mentioned general formula. As described above, when the positive active material (B) expressed by the above-mentioned general formula is once charged to about 4.5 to 4.6 V to extract Li ions, the positive active material (B) is activated to have high capacity. However, at this time, a slight structural change is involved, and hence, about 10% of the extracted Li ions cannot be absorbed again to become irreversible capacity. Although various studies are being recently conducted in order to reduce the above-mentioned irreversible capacity in the positive active material (B), the irreversible capacity has not been sufficiently reduced.

On the other hand, the following is known about a lithium ion secondary battery. In the lithium ion secondary battery, a nonaqueous electrolyte solution component is decomposed to be deposited on the surface of a negative electrode by charge and discharge, and as a result, a solid electrolyte interface (SEI) coating film is formed on the surface of the negative electrode. A part of Li ions extracted from the positive active material during charge is taken in the SEI coating film and is not absorbed to the positive active material during discharge. The Li ions that are not absorbed to the positive active material become irreversible capacity.

In the case where a ratio of the mass of the positive active material (A) with respect to the total mass of the positive active material (A) and the positive active material (B) is set to 90% by mass or less, the energy density of the battery system can be enhanced, and Li ions corresponding to irreversible capacity in the positive active material (B) can be allocated to Li ions to be taken in the SEI coating film on the surface of the negative electrode. Therefore, the irreversible capacity of LiFePO₄ that is the positive active material (A) can be eliminated, and LiFePO₄ can be used effectively for a charge and discharge reaction. Further, from the viewpoint of enhancing the energy density of the battery system more satisfactorily, it is preferred that a ratio of the mass of the positive active material (A) with respect to the total mass of the positive active material (A) and the positive active material (B) be 87% by mass or less.

Further, in the case where a ratio of the mass of the positive active material (A) with respect to the total mass of the positive active material (A) and the positive active material (B) is the above-mentioned value, when a lithium ion secondary battery is subjected to normal charge and discharge, the positive active material (A) that is less degraded by charge and discharge mainly participates in the reaction. Therefore, even if charge and discharge are repeated, the degradation of the positive active material can be suppressed, and as a result, a lithium ion secondary battery in which large capacity is available over a long period of time (that is, which is excellent in charge and discharge cycle characteristics) also can be obtained.

The “ratio of the mass of the positive active material (A) with respect to the total mass of the positive active material (A) and the positive active material (B)” as used herein does not include the amount of carbon covering the surface of the positive active material (A).

As the positive active material in the positive electrode of the present invention, only the positive active material (A) and the positive active material (B) may be used, or other positive active materials as well as the positive active material (A) and the positive active material (B) may be used. Examples of the positive active materials other than the positive active material (A) and the positive active material (B) include lithium cobalt oxides such as LiCoO₂, lithium manganese oxides such as LiMnO₂ and Li₂MnO₃, lithium nickel oxides such as LiNiO₂, lithium-containing composite oxides having a spinel structure such as LiMn₂O₄ and Li_{4/3}Ti_{5/3}O₄, and oxides substituted with various kinds of elements having a basic composition of the above-mentioned oxides.

In the case where the other positive active materials are used together with the positive active material (A) and the positive active material (B), it is preferred that a ratio of the total mass of the positive active material (A) and the positive active material (B) in the entire positive active material is set to preferably 90% by mass or more, more preferably 95% by mass or more, from the viewpoint of ensuring the above-mentioned effects of the present invention satisfactorily. Further, as the positive active material in the positive electrode of the present invention, it is particularly preferred to use only the positive active material (A) and the positive active material (B).

As the binder to be included in the positive electrode mixture layer of the positive electrode of the present invention, the same binders as those used in positive electrode mixture layers included in positive electrodes for conventionally known lithium ion secondary batteries can be used. Specifically, preferred examples of the binder include polyvinylidene fluoride (PVDF), polytetrafluoroethylene (PTFE), styrene-butadiene rubber (SBR), and carboxymethyl cellulose (CMC).

Further, examples of the conductive aid to be included in the positive electrode mixture layer of the positive electrode of the present invention include graphite such as natural graphite (scalelike graphite, etc.) and artificial graphite; carbon black such as acetylene black, ketjen black, channel black, furnace black, lampblack, and thermal black; and carbon fibers.

Regarding the mass ratio of each component in the positive electrode mixture layer, for example, it is preferred that the mass ratio of the positive active material be set to 75 to 95% by mass, that of the binder be set to 2 to 15% by mass, and that of the conductive aid be set to 2 to 15% by mass. Further, it is preferred that the thickness of the positive electrode mixture layer (thickness thereof on one surface of a collector in the case where the positive electrode mixture layer is formed on both surfaces of the collector) be set to 30 to 180 μm.

The positive electrode of the present invention can be produced, for example, by coating one surface or both surfaces of a collector with a composition containing a positive electrode mixture (paste, slurry, etc.) prepared by dispersing a positive electrode mixture containing a positive active material (A), a positive active material (B), a binder, and a conductive aid in an organic solvent such as N-methyl-2-pyrrolidone (NMP) or a solvent such as water, drying the composition, and subjecting the composition to press treatment, as necessary.

Further, as necessary, a lead body for electrically connecting the positive electrode to other members in the lithium ion secondary battery may be formed on the positive electrode by a routine process.

As the collector of the positive electrode of the present invention, an aluminum foil, a perforated metal, a net, an expanded metal, or the like can be used. In general, an aluminum foil is used. It is preferred that the thickness of the collector be 10 to 30 μm.

The configuration and structure of the lithium ion secondary battery of the present invention are not particularly limited as long as the lithium ion secondary battery includes a positive electrode, a negative electrode, a separator, and a nonaqueous electrolyte solution, and the positive electrode of the present invention is used. Various configurations and structures utilized in conventionally known lithium ion secondary batteries can be used.

As the negative electrode of the lithium ion secondary battery of the present invention, for example, a negative electrode having a structure, in which a negative electrode mixture layer including a negative active material and a binder, and a conductive aid, as necessary, is formed on one surface or both surfaces of a collector, can be used.

Examples of the negative active material include carbon materials such as graphite (natural graphite such as scalelike graphite; artificial graphite obtained by graphitizing easily graphitized carbon such as pyrolytic carbons, mesophase carbon microbeads (MCMB), and carbon fibers at 2,800° C. or more), pyrolytic carbons, cokes, glass carbons, fired bodies of organic polymer compounds, MCMB, carbon fibers, and activated carbon; metals that can be alloyed with lithium (Si, Sn, etc.), and materials containing these metals (alloys, oxides, etc.), and one or at least two kinds thereof can be used.

Of the illustrated negative active materials, graphite and MCMB are preferred because these materials do not undergo a potential change often during charge and discharge, and more flat charge and discharge curves are obtained.

Further, particularly in order to achieve high capacity of a lithium ion secondary battery, it is preferred to use a material containing Si and O as constituent elements (provided that an atomic ratio x of O with respect to Si is 0.5≦x≦1.5. Hereinafter, the material is referred to as “SiOₓ”).

SiOₓ may contain a microcrystal or an amorphous phase of Si, and in this case, an atomic ratio between Si and O becomes a ratio including a microcrystal or an amorphous phase of Si. That is, SiOₓ includes a structure in which Si (for example, microcrystalline Si) is dispersed in an amorphous SiO₂ matrix, and the atomic ratio x of a combination of the amorphous SiO₂ and Si dispersed therein only needs to satisfy 0.5≦x≦1.5. For example, in the case of a material having a molar ratio between SiO₂ and Si of 1:1, having a structure in which Si is dispersed in an amorphous SiO₂ matrix, x is equal to 1, and hence, a structural formula is expressed as SiO. In the case of a material with such a structure, although a peak caused by the presence of Si (microcrystal Si) may not be observed, for example, in X-ray diffraction analysis, the presence of minute Si can be confirmed by observation with a transmitting electron microscope.

It is preferred that SiOₓ be a composite formed with a carbon material, and for example, the surface of SiOₓ is desirably covered with the carbon material. SiOₓ does not have sufficient conductivity. Therefore, when SiOₓ is used as a negative active material, it is necessary to use a conductive material (conductive aid) to improve mixing and dispersion between the SiOₓ and the conductive material in a negative electrode to form an excellent conductive network, from the viewpoint of ensuring satisfactory battery characteristics. When SiOₓ and a carbon material are formed into a composite, a conductive network in the negative electrode is formed satisfactorily to enhance load characteristics of a battery, for example, compared with the case of using a material obtained by merely mixing SiOₓ with a conductive material such as a carbon material.

Examples of the composite of SiOₓ and a carbon material include SiOₓ the surface of which is covered with a carbon material as described above, and granules of SiOₓ and a carbon material.

Further, the above-mentioned composite of SiOₓ and a carbon material can be further formed into a composite with a conductive material (carbon material, etc.). Examples thereof include composite granules obtained by granulating SiOₓ the surface of which is covered with a carbon material together with another carbon material, and composite granules obtained by covering the surfaces of granules of SiOₓ and a carbon material with another carbon material. When such composite granules are used as a negative active material, a more satisfactory conductive network can be formed in a negative electrode. Therefore, a lithium ion secondary battery having higher capacity and being more excellent in battery characteristics (for example, charge and discharge cycle characteristics) can be realized.

Further, when the composite granules contain SiOₓ and a carbon material dispersed uniformly, a more satisfactory conductive network can be formed. Therefore, battery characteristics such as heavy-load discharge characteristics can be further enhanced in a lithium ion secondary battery having a negative electrode containing SiOₓ as a negative active material.

Examples of the above-mentioned carbon material to be used for forming a composite with SiOₓ include carbon materials such as low-crystalline carbon, carbon nanotube, and vapor-grown carbon fibers.

It is preferred that the carbon material be at least one kind of material selected from the group consisting of a fibrous or coiled carbon material, carbon black (including acetylene black, ketjen black), artificial graphite, easily graphitized carbon, and hardly graphitized carbon. The fibrous or coiled carbon material is preferred in that this material forms a conductive network easily and has a large surface area. Carbon black (including acetylene black, ketjen black), easily graphitized carbon, and hardly graphitized carbon are preferred in that they have high electric conductivity and a high liquid-retention property and further have a property of easily keeping in contact with SiOₓ particles even when the SiOₓ particles expand or contract.

In the case of using SiOₓ as a negative active material, it is preferred that graphite also be used as the negative active material as described later, and this graphite also can be used as a carbon material for a composite of SiOₓ and a carbon material. Graphite also has high electric conductivity and a high liquid-retention property in the same way as in carbon black, and further has a property of easily keeping in contact with SiOₓ particles even when the SiOₓ particles expand or contract. Therefore, graphite can be used preferably for forming a composite with SiOₓ.

Of the illustrated carbon materials, the fibrous carbon material is particularly preferred to be used in the case where a composite with SiOₓ is granules for the following reason. Due to the thin thread shape and high flexibility, the fibrous carbon material can follow the expansion and contraction of SiOₓ involved in charge and discharge of a battery. Further, the fibrous carbon material has large bulk density, and hence, can have a number of connection points with the SiOₓ particles. Examples of the fibrous carbon include polyacrylonitrile (PAN)-based carbon fibers, pitch-based carbon fibers, vapor deposition carbon fibers, and carbon nanotube. Any one of them may be used.

The fibrous carbon material also can be formed on the surfaces of SiOₓ particles, for example, by a gas-phase method.

SiOₓ generally has a specific resistance of 10³ to 10⁷ kΩcm, whereas the illustrated carbon material generally has a specific resistance of 10⁻⁵ to 10 kΩcm.

Further, a composite of SiOₓ and a carbon material further may include a material layer (material layer containing hardly graphitized carbon) covering a carbon material covering layer on the surface of each particle.

In the case where a composite of SiOₓ and a carbon material is used for a negative electrode, it is preferred that a ratio of the carbon material be 5 parts by mass or more, more preferably 10 parts by mass or more with respect to 100 parts by mass of SiOₓ, from the viewpoint of allowing the composite to exhibit its function satisfactorily. Further, in the composite, when a ratio of the carbon material that forms a composite with SiOₓ is too high, the amount of SiOₓ in a negative electrode mixture layer decreases, which may degrade the effect of increased capacity. Therefore, a ratio of the carbon material is preferably 50 parts by mass or less, more preferably 40 parts by mass or less with respect to 100 parts by mass of SiOₓ.

The above-mentioned composite of SiOₓ and a carbon material can be obtained, for example, by the following method.

First, a method for producing SiOₓ is described. Examples of SiOₓ include primary particles of SiOₓ, SiOₓ composite particles including a plurality of particles, and granules of SiOₓ and a carbon material, which are sometimes referred to as “SiOₓ particles” collectively.

The primary particles of SiOₓ are obtained by a method for heating a mixture of Si and SiO₂, and cooling gas of the generated silicon oxide to deposit SiOₓ. The resultant SiOₓ is further subjected to heat treatment in an inactive gas atmosphere, whereby a minute Si phase can be formed in the particles. At this time, by adjusting a heat treatment temperature and time, a half-value width of a (111) diffraction peak of a Si phase to be formed can be controlled. In general, the heat treatment temperature is set in a range of about 900 to 1,400° C., and the heat treatment time is set in a range of about 0.1 to 10 hours.

The SiOₓ composite particles are obtained, for example, by preparing a dispersion liquid in which SiOₓ is dispersed in a dispersion medium, and spraying and drying the dispersion liquid. As the dispersion medium, for example, ethanol can be used. The dispersion liquid is generally sprayed in an atmosphere of 50 to 300° C. Similar composite particles also can be produced by a granulation method based on a mechanical process using a vibration or planetary ball mill, rod mill, or the like besides the above-mentioned method.

The granules of SiOₓ and a carbon material are obtained, for example, by a procedure similar to that in the case of adding a carbon material having a specific resistance smaller than that of SiOₓ to a dispersion liquid in which SiOₓ is dispersed in a dispersion medium, and forming a composite of the above-mentioned SiOₓ with the dispersion liquid. Further, the granules of SiOₓ and a carbon material can be produced also by the above-mentioned granulation method based on a mechanical process using a vibration or planetary ball mill, rod mill, or the like.

Next, a method for producing a composite of SiOₓ and a carbon material is described. The composite of SiOₓ and a carbon material is obtained, for example, by heating SiOₓ particles (SiOₓ composite particles or granules of SiOₓ and a carbon material) and hydrocarbon based gas in a gas phase and depositing carbon generated by thermal decomposition of the hydrocarbon based gas on the surfaces of the SiOₓ particles. By producing the composite of SiOₓ and a carbon material through use of a CVD method in this manner, the hydrocarbon based gas spreads sufficiently to the SiOₓ particles, and a thin and uniform coating film (carbon material covering layer) containing a conductive carbon material can be formed on the surfaces of the particles and in the holes thereof. As a result, conductivity can be conferred on the SiOₓ particles uniformly with a small amount of carbon material.

The treatment temperature (ambient temperature) in the CVD method is generally 600 to 1,200° C., although it depends upon the kind of hydrocarbon based gas. Above all, the treatment temperature is preferably 700° C. or more, more preferably 800° C. or more. The reason for this is as follows: as the treatment temperature is higher, the amount of remaining impurities is smaller, and a covering layer containing a highly conductive carbon material can be formed.

As a liquid source of the above-mentioned hydrocarbon based gas, toluene, benzene, xylene, mesitylene, or the like can be used, and toluene that is easy to handle is particularly preferred. Hydrocarbon based gas can be obtained by vaporizing any of these sources (for example, causing bubbling with nitrogen gas). Further, methane gas, acetylene gas, or the like also can be used.

Alternatively, the following may be performed. The surfaces of SiOₓ particles (SiOₓ composite particles or granules of SiOₓ and a carbon material) are covered with a carbon material by the CVD method. After that, at least one kind of an organic compound selected from the group consisting of a petroleum pitch, a coal-based pitch, a thermosetting resin, and a condensate of a naphthalenesulfonate and aldehydes is allowed to adhere to the covering layer containing the carbon material, and then, the particles to which the organic compound has adhered are fired.

Specifically, a dispersion liquid, in which SiOₓ particles (SiOₓ composite particles or granules of SiOₓ and a carbon material) the surfaces of which are covered with a carbon material and the above-mentioned organic compound are dispersed in a dispersion medium, is prepared. The dispersion liquid is sprayed and dried to form particles covered with the organic compound, and the particles covered with the organic compound are fired.

As the above-mentioned pitch, an isotropic pitch can be used. As the thermosetting resin, a phenol resin, a furan resin, a furfural, or the like can be used. As the condensate of a naphthalenesulfonate and aldehydes, a formaldehyde naphthalenesulfonate condensate can be used.

As the dispersion medium for dispersing SiOₓ particles the surfaces of which are covered with a carbon material and the above-mentioned organic compound, for example, water or alcohols (ethanol, etc.) can be used. The dispersion liquid is generally sprayed in an atmosphere of 50 to 300° C. The firing temperature is generally 600 to 1,200° C., and above all, the firing temperature is preferably 700° C. or more, more preferably 800° C. or more. The reason for this is as follows: as the treatment temperature is higher, the amount of remaining impurities is smaller, and a covering layer containing a highly conductive carbon material of good quality can be formed. In this case, it should be noted that the treatment temperature is required to be a melting point of SiOₓ or less.

In the case of using SiOₓ (preferably, a composite of SiOₓ and a carbon material) as a negative active material, it is preferred that graphite also be used. While SiOₓ has high capacity compared with a carbon material generally used in a negative active material of a lithium ion secondary battery, SiOₓ greatly changes in volume during charge and discharge of the battery. Therefore, in a lithium ion secondary battery using a negative electrode having a negative electrode mixture layer containing a large amount of SiOₓ, there is a possibility that the negative electrode (negative electrode mixture layer) greatly changes in volume to be degraded due to repeated charge and discharge, and capacity decreases (that is, charge and discharge cycle characteristics are degraded). Graphite is generally used as a negative active material of a lithium ion secondary battery and has relatively large capacity, and on the other hand, graphite changes less in volume during charge and discharge of a battery, compared with SiOₓ. Therefore, by using SiOₓ together with graphite as a negative active material, the capacity enhancing effect of a battery is prevented as soon as possible from decreasing along with a reduction in use amount of SiOₓ, and charge and discharge cycle characteristics of a battery can be prevented satisfactorily from being degraded. As a result, a lithium ion secondary battery having higher capacity and being excellent in charge and discharge cycle characteristics can be obtained.

Examples of the graphite to be used as a negative active material together with SiOₓ include natural graphite such as scalelike graphite, pyrolytic carbons, MCMB, and artificial graphite obtained by graphitizing easily graphitized carbon such as carbon fibers at 2,800° C. or more.

In the case of using a composite of SiOₓ and a carbon material together with graphite as a negative active material, a ratio of the mass of the composite of SiOₓ and a carbon material in the entire negative active material is preferably 0.01% by mass or more, more preferably 1% by mass or more, still more preferably 3% by mass or more, from the viewpoint of satisfactorily ensuring the effect of achieving high capacity by using SiOₓ. Further, from the viewpoint of satisfactorily avoiding a problem caused by a change in volume of SiOₓ involved in charge and discharge, a ratio of the mass of the composite of SiOₓ and a carbon material in the entire negative active material is preferably 20% by mass or less, more preferably 15% by mass or less.

Further, as the binder and the conductive aid of the negative electrode, the same materials as those illustrated previously to be used for the positive electrode can be used.

Regarding a mass ratio of each component in the negative electrode mixture layer, for example, it is preferred that the mass ratio of the negative active material be set to 80.0 to 99.8% by mass, and that of the binder be set to 0.1 to 10% by mass. Further, in the case where the negative electrode mixture layer contains a conductive aid, it is preferred that the amount of the conductive aid in the negative electrode mixture layer be set to 0.1 to 10% by mass. Further, it is preferred that the thickness of the negative electrode mixture layer (thickness thereof on one surface of a collector in the case where the negative electrode mixture layer is formed on both surfaces of the collector) be 10 to 100 μm.

The negative electrode can be produced, for example, by coating one surface or both surfaces of a collector with a composition containing a negative electrode mixture (paste, slurry, etc.) prepared by dispersing a negative electrode mixture containing a negative active material and a binder, and a conductive aid to be used as necessary in an organic solvent such as NMP or a solvent such as water, drying the composition, and subjecting the composition to press treatment, as necessary.

Further, as necessary, a lead body for electrically connecting the negative electrode to other members in the lithium ion secondary battery may be formed on the negative electrode by a routine process.

As the collector of the negative electrode, a copper foil, a nickel foil, a perforated metal, a net, an expanded metal, or the like can be used. In general, a copper foil is used. In the case of reducing the thickness of an entire negative electrode so as to obtain a battery with high energy density, the upper limit of the thickness of the collector is preferably 30 μm, and the lower limit thereof is desirably 5 μm so as to ensure mechanical strength.

As a nonaqueous electrolyte solution of the lithium ion secondary battery of the present invention, a solution in which a lithium salt is dissolved in a nonaqueous solvent generally is used.

As a solvent for the nonaqueous electrolyte solution, for example, nonprotic organic solvents such as ethylene carbonate (EC), propylene carbonate (PC), butylene carbonate (BC), dimethyl carbonate (DMC), diethyl carbonate (DEC), methyl ethyl carbonate (MEC), γ-butylolactone (γ-BL), 1,2-dimethoxyethane (DME), tetrahydrofuran (THF), 2-methyltetrahydrofuran, dimethylsulfoxide (DMSO), 1,3-dioxolane, formamide, dimethylformamide (DMF), dioxolane, acetonitrile, nitromethane, methyl formate, methyl acetate, toriester phosphate, trimethoxymethane, a dioxolane derivative, sulfolane, 3-methyl-2-oxazolidinone, a propylene carbonate derivative, a tetrahydrofuran derivative, diethyl ether, and 1,3-propanesultone can be used alone or as a mixed solvent of a mixture of at least two kinds thereof.

As the lithium salt dissolved in the nonaqueous electrolyte solution, for example at least one kind selected from lithium salts such as LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7), and LiN (RfOSO₂)₂ (where Rf represents a fluoroalkyl group) can be used. The concentration of these lithium salts in the nonaqueous electrolyte solution is set to preferably 0.6 to 1.8 mol/L, more preferably 0.9 to 1.6 mol/L.

An acid anhydride, a sulfonic acid ester, dinitrile, 1,3-propanesultone, diphenyldisulfide, biphenyl, cyclohexylbenzene, fluorobenzene, t-butylbenzene, vinylene carbonate (VC), and derivatives thereof, and additives (including those derivatives) such as halogen-substituted cyclic carbonate (4-fluoro-1.3-dioxolane-2-one (FEC), etc.) also can be added as appropriate to the nonaqueous electrolyte solution used in the lithium ion secondary battery, for the purpose of further improving charge and discharge cycle characteristics and further enhancing a high-temperature storage property and safety such as prevention of overcharge.

Further, a gelling agent made of a polymer may be added to the nonaqueous electrolyte solution so as to be used as a gel (gel electrolyte).

It is preferred that the separator included in the lithium ion secondary battery of the present invention have a property for closing its holes (that is, a shutdown function) at 80° C. or more (more preferably 100° C. or more) and 170° C. or less (more preferably 150° C. or less), and separators used in general lithium ion secondary batteries, for example, a microporous film made of polyolefin such as polyethylene (PE) or polypropylene (PP) can be used. The microporous film constituting the separator may be, for example, a film using only PE or a film using only PP, or a laminate of a microporous film made of PE and a microporous film made of PP. It is preferred that the thickness of the separator be, for example, 10 to 30 μm.

A laminated separator may be used, in which a heat-resistant layer containing a heat-resistant inorganic filler such as silica, alumina, boehmite, or the like is formed on one surface or both surfaces of the above-mentioned microporous film made of polyolefin.

The separator can be used in the lithium ion secondary battery of the present invention in the form of a laminated electrode member in which the above-mentioned positive electrode of the present invention and the above-mentioned negative electrode are laminated with the above-mentioned separator interposed therebetween, or a wound electrode member obtained by further winding the laminated electrode member in a spiral shape.

The lithium ion secondary battery of the present invention is produced, for example, by loading a laminated electrode member or a wound electrode member into a battery outer body, injecting a nonaqueous electrolyte solution into the battery outer body to soak the electrode member in the nonaqueous electrolyte solution, and sealing an opening of the battery outer body. As the battery outer body, a tubular (rectangular cylinder-shaped or cylindrical, etc.) battery outer can made of steel metal, aluminum, or an aluminum alloy, a battery outer body formed of a metal-deposited laminate film, or the like can be used.

When the lithium ion secondary battery of the present invention is used in a battery system having a charge and discharge control portion for controlling charge and discharge of the battery with a voltage, the effective capacity thereof can be enhanced, and high energy density can be realized.

That is, the battery system of the present invention includes the lithium ion secondary battery of the present invention and the above-mentioned charge and discharge control portion, and as the other configuration and structure thereof, those which have been adopted in various conventionally known battery systems can be used. Specifically, the battery system may include, for example, a battery, a rack for fixing a battery pack (described later) and a battery module thereto, a cooling fan, and the like. Further, as the above-mentioned charge and discharge control portion, the same charge and discharge control portion for a lithium ion secondary battery adopted in conventionally known battery systems also can be used.

The battery system of the present invention includes one or at least two lithium ion secondary batteries of the present invention, and the lithium ion secondary batteries used in the battery system of the present invention may be provided in the form of a battery pack in which a plurality of lithium ion secondary batteries are packaged into one pack, or a battery module having a plurality of such battery packs.

Due to the large effective capacity and high energy density, the battery system of the present invention can be used for storage batteries for generators and the same applications as those of various known battery systems having lithium ion secondary batteries.

Hereinafter, the present invention is described in detail by way of examples. It should be noted that the present invention is not limited to the following examples.

### Example 1

### Production of Positive Electrode

A mixture containing LiFePO₄ as a positive active material (A) and 0.55Li₂MnO₃.0.45Li(Ni_{2/5}Mn_{2/5}Co_{1/5})O₂ as a positive active material (B) in a mass ratio of 85:15 was prepared. The LiFePO₄ was obtained by mixing iron phosphate, lithium phosphate, and sucrose, and firing the mixture in nitrogen gas at 800° C. The surface of the LiFePO₄ was covered with carbon, and the amount of carbon covering the surface was 2.3 parts by mass with respect to 100 parts by mass of the LiFePO₄. Further, the 0.55Li₂MnO₃.0.45Li(Ni_{2/5}Mn_{2/5}Co_{1/5})O₂ was obtained by mixing nickel hydroxide, manganese hydroxide, cobalt hydroxide, and lithium hydroxide so as to obtain the above-mentioned composition ratio, and firing the mixture in the air at 750° C. for 20 hours. The 0.55Li₂MnO₃.0.45Li(Ni_{2/5}Mn_{2/5}Co_{1/5})O₂ had an average primary particle diameter of 2.1 μm.

Then, 88 parts by mass of the mixture as a positive active material, 4.3 parts by mass of acetylene black as a conductive aid, and 7.7 parts by mass of PVDF as a binder were dispersed in NMP as a solvent to prepare a composition containing a positive electrode mixture. The composition containing a positive electrode mixture was applied to one surface of an aluminum foil with a thickness of 15 μm to be a collector and dried, and the resultant composition was subjected to press treatment. After that, the aluminum foil thus obtained was cut to a size of 30×30 mm to produce a positive electrode. A positive electrode mixture layer of the positive electrode thus produced had a thickness of 113 μm, a density of 1.95 g/cm³, and a capacity density of 3.6 mAh/cm².

### (Production of Negative Electrode)

First, 98 parts by mass of scalelike graphite as a negative active material (manufactured by Hitachi Chemical Industry Co., Ltd.), 1 part by mass of CMC as a binder, and 1 part by mass of SBR as a binder were dispersed in water as a solvent to prepare a composition containing a negative electrode mixture. The composition containing a negative electrode mixture was applied to one surface of a copper foil with a thickness of 8 μm to be a collector and dried, and the resultant composition was subjected to press treatment. After that, the copper foil was cut to a size of 35×35 mm to produce a negative electrode. A negative electrode mixture layer of the negative electrode thus produced had a thickness of 91 μm, a density of 1.4 g/cm³, and a capacity density of 4.6 mAh/cm².

### (Preparation of Nonaqueous Electrolyte Solution)

LiPF₆ as a lithium salt was dissolved in a concentration of 1.2 mol/L in a mixed solvent containing ethylene carbonate and diethyl carbonate in a volume ratio of 3:7 to prepare a nonaqueous electrolyte solution.

### (Assembly of Battery)

The above-mentioned positive electrode and the above-mentioned negative electrode were laminated with a separator (microporous film made of PE with a thickness of 16 μm) interposed therebetween, and the laminate was inserted in a laminate film battery outer body. The above-mentioned nonaqueous electrolyte solution was injected into the laminate film battery outer body, and the laminate film battery outer body was sealed to produce a lithium ion secondary battery.

### Example 2

A lithium ion secondary battery was produced in the same way as in Example 1, except that a positive electrode was produced in the same way as in Example 1 except for using 0.6Li₂MnO₃.0.4Li(Ni_{1/3}Mn_{1/3}Co_{1/3})O₂ instead of the positive active material (B) and changing a ratio between the positive active material (A) and the positive active material (B) in a mixture of the positive active material (A) and the positive active material (B) to 90:10 in a mass ratio, and that the positive electrode thus produced was used. The positive active material (B) was synthesized in the same way as in Example 1 except for using each material so as to obtain the above-mentioned composition ratio. The positive active material (B) had an average primary particle diameter of 2.3 μm.

### Example 3

A lithium ion secondary battery was produced in the same way as in Example 1, except that a positive electrode was produced in the same way as in Example 1 except for using 0.3Li₂MnO₃.0.7Li(Ni_{1/4}Mn_{1/4}Co_{1/2})O₂ instead of the positive active material (B) and changing a ratio between the positive active material (A) and the positive active material (B) in a mixture of the positive active material (A) and the positive active material (B) to 80:20 in a mass ratio, and that the positive electrode thus produced was used. The positive active material (B) was synthesized in the same way as in Example 1 except for using each material so as to obtain the above-mentioned composition ratio. The positive active material (B) had an average primary particle diameter of 1.8 μm.

### Example 4

A lithium ion secondary battery was produced in the same way as in Example 1, except that a positive electrode was produced in the same way as in Example 1 except for using 0.45Li₂MnO₃.0.55Li(Ni_{1/5}Mn_{1/5}Co_{3/5})O₂ instead of the positive active material (B) and that the positive electrode thus produced was used. The positive active material (B) was synthesized in the same way as in Example 1 except for using each material so as to obtain the above-mentioned composition ratio. The positive active material (B) had an average primary particle diameter of 1.7 μm.

### Example 5

A lithium ion secondary battery was produced in the same way as in Example 1, except that a positive electrode was produced in the same way as in Example 1 except for using 0.65Li₂MnO₃.0.35Li(Ni_{1/3}Mn_{1/3}Co_{1/3})O₂ instead of the positive active material (B) and that the positive electrode thus produced was used. The positive active material (B) was synthesized in the same way as in Example 1 except for using each material so as to obtain the above-mentioned composition ratio. The positive active material (B) had an average primary particle diameter of 2.1 μm.

### Example 6

A lithium ion secondary battery was produced in the same way as in Example 1, except that a positive electrode was produced in the same way as in Example 1 except for using 0.45Li₂MnO₃.0.55Li(Ni_{1/3}Mn_{1/3}Fe_{1/3})O₂ instead of the positive active material (B) and that the positive electrode thus produced was used. The positive active material (B) was synthesized in the same way as in Example 1, except for using the same materials as those of Example 1 in which iron hydroxide was used instead of cobalt hydroxide so that the respective materials had the above-mentioned composition ratio. The positive active material (B) had an average primary particle diameter of 1.5 μm.

### Comparative Example 1

A lithium ion secondary battery was produced in the same way as in Example 1, except that a positive electrode was produced in the same way as in Example 1 except for using only LiFePO₄ (same as that used in Example 1) the surface of which was covered with carbon as the positive active material and that the positive electrode thus produced was used.

### Comparative Example 2

A lithium ion secondary battery was produced in the same way as in Example 1, except that a positive electrode was produced in the same way as in Example 1 except for using Li(Ni_{1/3}Mn_{1/3}Co_{1/3})O₂ as the positive active material instead of a mixture of the positive active material (A) and the positive active material (B) and that the positive electrode thus produced was used.

### Comparative Example 3

A lithium ion secondary battery was produced in the same way as in Example 1, except that a positive electrode was produced in the same way as in Example 1 except for using, as the positive active material, only the same positive active material (B) (0.55 Li₂MnO₃.0.45Li(Ni_{2/5}Mn_{2/5}Co_{1/5})O₂) as that used in Example 1 without using the positive active material (A) and that the positive electrode thus produced was used.

### Comparative Example 4

A lithium ion secondary battery was produced in the same way as in Example 1, except that a positive electrode was produced in the same way as in Example 1 except for using Li(Ni_{1/3}Mn_{1/3}Co_{1/3})O₂ instead of the positive active material (B) and that the positive electrode thus produced was used.

### Comparative Example 5

A lithium ion secondary battery was produced in the same way as in Example 1, except that a positive electrode was produced in the same way as in Example 1 except for changing a ratio between the positive active material (A) and the positive active material (B) in a mixture of the positive active material (A) and the positive active material (B) to 75:25 in a mass ratio and that the positive electrode thus produced was used.

### Comparative Example 6

A lithium ion secondary battery was produced in the same way as in Example 1, except that a positive electrode was produced in the same way as in Example 1 except for changing a ratio between the positive active material (A) and the positive active material (B) in a mixture of the positive active material (A) and the positive active material (B) to 95:5 in a mass ratio and that the positive electrode thus produced was used.

Each lithium ion secondary battery of the examples and the comparative examples was incorporated into a battery system having a charge and discharge control portion for controlling charge and discharge with a voltage. Then, charge and discharge characteristics were measured at a current value of 0.2C through use of these battery systems.

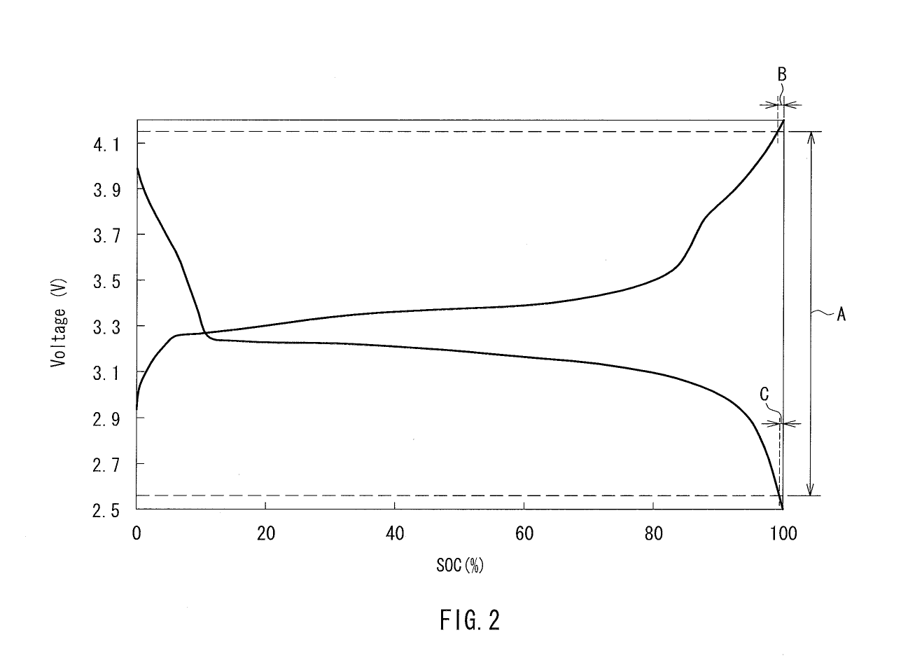

In the measurement of charge and discharge characteristics, each battery system was subjected to charge and discharge between predetermined voltages at a current value of 0.2C to obtain energy density per 1 kg of a positive active material of each battery, and charge and discharge curves showing a relationship between the SOC of each battery and the voltage was created. With a range of 2.55 to 4.15 V being set to a substantially available voltage range, unused capacity (total value of “capacity B that is not substantially available during charge” and “capacity C that is not substantially available during discharge” shown in FIG. 2 described later) was obtained.

The positive active material (B) used in each lithium ion secondary battery of the examples and the comparative examples was a positive active material available up to about 4.7 V. Therefore, in the battery systems having the respective lithium ion secondary batteries of Examples 1-6 and Comparative Examples 3, 5, and 6 using the positive active material (B), both the charge and discharge characteristics at 2.5 to 4.7 V and the charge and discharge characteristics at 2.5 to 4.2 V were measured. On the other hand, in the battery systems having the batteries of Comparative Examples 1, 2, and 4 not using the positive active material (B), only the charge and discharge characteristics at 2.5 to 4.2 V were measured.

Table 1 shows a configuration of the positive active material used in each lithium ion secondary battery of the examples and the comparative examples, and Table 2 shows a measurement result of charge and discharge characteristics of each lithium ion secondary battery of the examples and the comparative examples.

TABLE 1

| | Positive | | | | | | |
|---|---|---|---|---|---|---|---|
| | active | Positive active material (B) | | | | | |
| | material (A) | | | Composition of | | | |
| | Ratio | Ratio | | elements M | | | |
| | (mass %) | (mass %) | y | Ni | Mn | Co | Fe |
| Example 1 | 85 | 15 | 0.55 | 2/5 | 2/5 | 1/5 | — |
| Example 2 | 90 | 10 | 0.60 | 1/3 | 1/3 | 1/3 | — |
| Example 3 | 80 | 20 | 0.30 | 1/4 | 1/4 | 1/2 | — |
| Example 4 | 85 | 15 | 0.45 | 1/5 | 1/5 | 3/5 | — |
| Example 5 | 85 | 15 | 0.65 | 1/3 | 1/3 | 1/3 | — |
| Example 6 | 85 | 15 | 0.45 | 1/3 | 1/3 | — | 1/3 |
| Comparative | 100 | 0 | — | — | — | — | — |
| Example 1 | | | | | | | |
| Comparative | 0 | 100 | 0 | 1/3 | 1/3 | 1/3 | — |
| Example 2 | | | | | | | |
| Comparative | 0 | 100 | 0.55 | 2/5 | 2/5 | 1/5 | — |
| Example 3 | | | | | | | |
| Comparative | 85 | 15 | 0 | 1/3 | 1/3 | 1/3 | — |
| Example 4 | | | | | | | |
| Comparative | 75 | 25 | 0.55 | 2/5 | 2/5 | 1/5 | — |
| Example 5 | | | | | | | |
| Comparative | 95 | 5 | 0.55 | 2/5 | 2/5 | 1/5 | — |
| Example 6 | | | | | | | |

TABLE 2

| | Energy density per | | |
|---|---|---|---|
| | unit mass of positive | | |
| | active material (Wh/kg) | | Unused capacity |
| | 2.5 to 4.2 V | 2.5 to 4.7 V | at 2.5 to 4.2 V (%) |
| Example 1 | 530 | 549 | 1.26 |
| Example 2 | 507 | 519 | 0.89 |
| Example 3 | 568 | 597 | 1.88 |
| Example 4 | 544 | 566 | 1.21 |
| Example 5 | 518 | 536 | 1.47 |
| Example 6 | 528 | 548 | 1.11 |
| Comparative | 471 | — | 0.23 |
| Example 1 | | | |
| Comparative | 528 | — | 4.48 |
| Example 2 | | | |
| Comparative | 870 | 1003 | 4.17 |
| Example 3 | | | |
| Comparative | 480 | — | 0.51 |
| Example 4 | | | |
| Comparative | 571 | 605 | 3.15 |
| Example 5 | | | |
| Comparative | 492 | 498 | 0.29 |
| Example 6 | | | |

Although Li(Ni_{1/3}Mn_{1/3}CO_{1/3})O₂ used in Comparative Examples 2 and 4 does not correspond to the positive active material (B), Li(Ni_{1/3}Mn_{1/3}Co_{1/3})O₂ is described in the section “Positive active material (B)” for convenience sake in Table 1, and the composition of Ni, Mn, and Co in this positive active material is described in the section “Composition of elements M”. Further, the “ratio” between the positive active material (A) and the positive active material (B) in Table 1 means a mass ratio with respect to the total mass of the positive active material (A) and the positive active material (B).

As is apparent from Tables 1 and 2, in the battery systems including the lithium ion secondary batteries of Examples 1 to 6 each having a positive electrode using the positive active material (A) and the positive active material (B) in an appropriate ratio, unused capacity at a time of measurement of charge and discharge characteristics at 2.5 to 4.2 V is suppressed to low (about 2%). Further, in the battery systems including the lithium ion secondary batteries of Examples 1 to 6, energy density obtained by measurement of charge and discharge characteristics at 2.5 to 4.2 V is 500 Wh/kg or more, and hence, high energy density is realized. In particular, in measurement of charge and discharge characteristics at 2.5 to 4.7 V, higher energy density can be ensured.

In contrast, in the battery system including the battery of Comparative Example 1 using only LiFePO₄ that is the positive active material (A) as a positive active material, the battery system of Comparative Example 4 using Li(Ni_{1/3}Mn_{1/3}Co_{1/3})O₂ as the positive active material (B), and the battery system including the battery of Comparative Example 6 in which a use ratio of the positive active material (A) is too high, energy density is low although unused capacity at a time of measurement of charge and discharge characteristics at 2.5 to 4.2 V is very small. Further, in the battery system including the battery of Comparative Example 2 using Li(Ni_{1/3}Mn_{1/3}Co_{1/3})O₂ as a positive active material, the battery system including the battery of Comparative Example 3 using only the positive active material (B) as a positive active material, and the battery system including the battery of Comparative Example 5 in which a use ratio of the positive active material (B) is too high, unused capacity at a time of measurement of charge and discharge characteristics at 2.5 to 4.2 V is large although energy density is high.

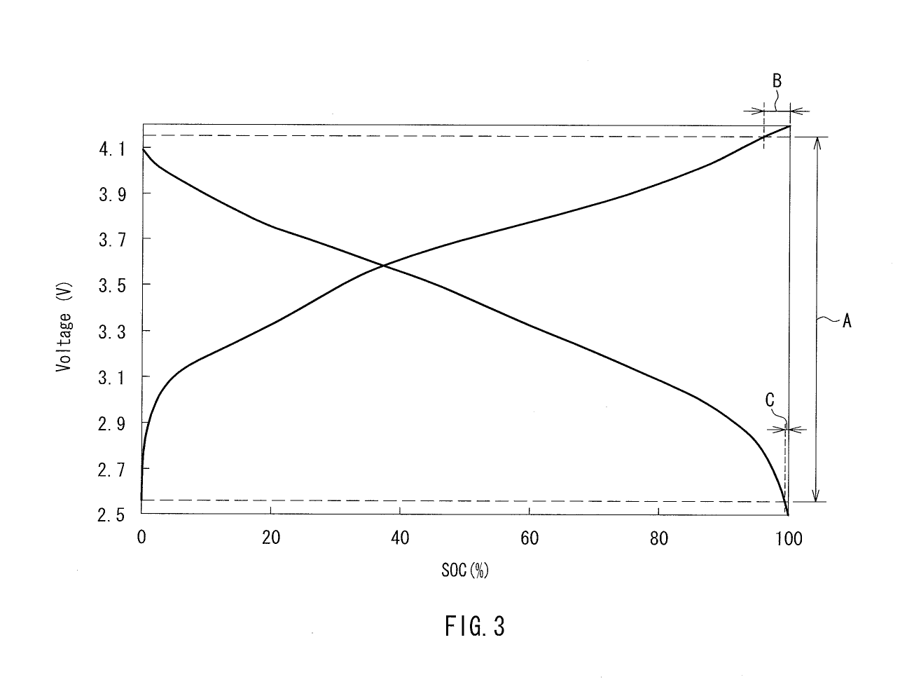

Further, FIG. 2 shows charge and discharge curves obtained by measuring charge and discharge characteristics at 2.5 to 4.2 V in the battery system including the lithium ion secondary battery of Example 1, and FIG. 3 shows charge and discharge curves obtained by measuring charge and discharge characteristics at 2.5 to 4.2 V in the battery system including the lithium ion secondary battery of Comparative Example 3. In FIGS. 2 and 3, a horizontal axis represents an SOC (%) of a lithium ion secondary battery, and a vertical axis represents a battery voltage (V). Reference symbol “A” represents a substantially available voltage range, “B” capacity that is not substantially available during charge in a high SOC region, and “C” capacity that is not substantially available during discharge in a high SOC region. In FIG. 2, the substantially available voltage range A is 2.55 to 4.15 V, the capacity B that is not substantially available during charge is 0.91%, and the capacity C that is not substantially available during discharge is 0.35%. In FIG. 3, the substantially available voltage range A is 2.55 to 4.15 V, the capacity B that is not substantially available during charge is 3.67%, and the capacity C that is not substantially available during discharge is 0.50%.

As is apparent from FIGS. 2 and 3, in the battery system including the lithium ion secondary battery of Comparative Example 3, a voltage rises smoothly in a wide SOC range in the charge curve, and hence, an SOC range in which a voltage exceeds 4.15 V is relatively large, and unused capacity is large. In contrast, in the battery system including the lithium ion secondary battery of Example 1, a region in which a voltage is flat is large in the charge curve, and a voltage rapidly rises in a very high SOC region, and hence, an SOC range in which a voltage exceeds 4.15 V is small, and the occurrence of unused capacity is suppressed.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A positive electrode for a lithium ion secondary battery, comprising a positive electrode mixture layer containing a positive active material, a conductive aid, and a binder,
wherein the positive electrode mixture layer contains, as the positive active material, a positive active material (A) that is LiFePO₄ having an olivine structure and a positive active material (B) expressed by a general formula: yLi₂MnO₃.(1−y)LiMO₂, where y satisfies 0.3≦y≦0.7, and M represents at least two kinds of elements selected from the group consisting of Co, Mn, Ni, Fe, and Ti so that a total valence become three, and
the positive active material (A) has a mass ratio of 80 to 90% by mass with respect to a total mass of the positive active material (A) and the positive active material (B).

2. The positive electrode for a lithium ion secondary battery according to claim 1, wherein the element M has any of compositions selected from the group consisting of Ni_{1/3}Mn_{1/3}Co_{1/3}, Ni_{1/4}Mn_{1/4}Co_{1/2}, Ni_{1/5}Mn_{1/5}Co_{3/5}, Ni_{2/5}Mn_{2/5}Co_{1/5}, and Ni_{1/3}Mn_{1/3}Fe_{1/3} in the general formula expressing the positive active material (B).

3. The positive electrode for a lithium ion secondary battery according to claim 1, wherein the positive active material (A) is covered with carbon.

4. The positive electrode for a lithium ion secondary battery according to claim 3, wherein the positive active material (A) is covered with the carbon in an amount of 1 to 5 parts by mass with respect to 100 parts by mass of the positive active material (A).

5. The positive electrode for a lithium ion secondary battery according to claim 1, wherein the positive active material (A) has a mass ratio of 82 to 87% by mass with respect to the total mass of the positive active material (A) and the positive active material (B).

6. A lithium ion secondary battery, comprising: a positive electrode; a negative electrode; a separator; and a nonaqueous electrolyte solution, wherein the positive electrode is the positive electrode for a lithium ion secondary battery according to claim 1.

7. A battery system, comprising: the lithium ion secondary battery according to claim 6; and a charge and discharge control portion for controlling charge and discharge of the lithium ion secondary battery with a voltage.
